(19) United States
(12) Patent Application Publication
(10) Pub. No.: US 2005/0275602 A1
(43) Pub. Date: Dec. 15, 2005

(54) Presentation system and associated method

(75) Inventors: Jonathan Murgolo, Staten Island, NY (US); Gary Kerber, Staten Island, NY (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: New Way Home Inc.

(21) Appl. No.: 10/868,747

(22) Filed: Jun. 15, 2004

(51) Int. Cl. G09G 5/00

(52) U.S. Cl. 345/1.1

(57) ABSTRACT

A system for presenting a unit is provided, comprising a first viewing medium configured to provide a static visual indicia of the unit. At least one second viewing medium disposed in proximity to the first viewing medium and is configured to provide a dynamic visual indicia of an aspect associated with the unit, concurrently with the static visual indicia of the unit provided by the first viewing medium. An associated method is also provided.

### BACKGROUND OF THE INVENTION

1. Field of the Invention

The present invention relates to a system and method for presenting a unit and, more particularly, to a system and method for presenting a static visual indicia of a unit concurrently with a dynamic visual indicia of an aspect associated with that unit.

2. Description of Related Art

When selling property or other item, such as a home or other real estate, effective selling of that item is often a matter of public exposure. That is, for example, if one has a home for sale, it is often preferable to post “for sale” notices such that a maximum number of possible home buyers are aware that the house is for sale, under the premise that maximum exposure and promotion of the item leads to a faster sale and, in some instances, maybe a better selling price (supply and demand). The same concept may apply in other areas where the promoted item may comprise, for instance, goods, services, a store, an attraction, or any other appropriate issue that may similarly benefit from widespread exposure. In addition, the widespread exposure often must be accompanied by an associated visual aid, since an image may be more likely to attract a person's interest to the item. Appropriate venues for such promotional material may include, for example, print media, television, and the Internet. Further, in some instances, such promotional material may be posted in an information booth or kiosk located in an area having high pedestrian traffic, such as a shopping mall or transportation hub.

Even though the promoted property, service, attraction, or the like may be clearly posted or otherwise accessible to the public, any interested party typically wants as much information as possible before pursuing interest in the promoted item. That is, a consumer may require enough information to answer potential questions, but may want to receive this information by expending the least amount of effort and spending the least amount of time possible. Regardless of the venue or the amount of available information, the interested party may quickly lose interest if the additional information requires affirmative action or work in order to be obtained.

In this regard, U.S. Patent Application Publication No. 2004/0046798A1 to Alen, for example, discloses a real estate presentation device and method for selling, leasing, renting, or presenting a portfolio of real estate, particularly combining images, text, video and audio of a real estate unit and providing the information over a communication network. However, in this Internet-implemented system, the user must “click through” in order to access further information on a property of interest. In a similar manner, U.S. Patent Application Publication No. 2003/0083957 to Olefson discloses a method and apparatus for selection and viewing of real estate properties that allows a buyer to view a real estate property without visiting the actual property. However, the user must select the property of interest and then “click through” in order to take a virtual interactive tour of the property. U.S. Patent Application Publication No. 2001/0034607 to Perschbacher, III et al. discloses a system for providing automated real estate services, wherein a person must physically move to a different location in order to obtain more information on a particular property after that particular property has been selected.

Accordingly, these examples illustrate systems that may not be desirable to an interested party or may not retain the interest of that party due to the affirmative actions and time commitment required in order to obtain further information. The interested party generally may not want to physically move, actively search, ask questions, follow embedded links, or spend excessive time in order to find more information on any property that may peak their interest. Thus, there exists a need for a presentation or promotional system in which the target audience is presented with information on a particular unit or item in a manner which provides a detailed and comprehensive description of the unit or item in a time-efficient manner, but does not require an interested party to take affirmative steps in order to receive that information.

### BRIEF SUMMARY OF THE INVENTION

The above and other needs are met by the present invention which, in one embodiment, provides a system for presenting a unit. A first viewing medium is configured to provide a static visual indicia of the unit. At least one second viewing medium is disposed in proximity to the first viewing medium and is configured to provide a dynamic visual indicia of an aspect associated with the unit, concurrently with the static visual indicia of the unit provided by the first viewing medium.

Another aspect of the present invention comprises a system for displaying an item. A first monitor device is configured to display a static image of a first aspect of the item. At least one second monitor device is disposed in proximity to the first monitor device and is configured to display a dynamic image of a second aspect associated with the item, concurrently with the static image of the first aspect of the item displayed by the first monitor device.

Yet another aspect of the present invention comprises a method of presenting a unit. A static visual indicia of the unit is provided on a first viewing medium. At least one dynamic visual indicia of an aspect associated with the unit is concurrently provided on a corresponding second viewing medium disposed in proximity to the static visual indicia of the unit provided on the first viewing medium.

Another aspect of the present invention comprises a method of displaying an item. A static image of a first aspect of the item is provided on a first monitor device. At least one dynamic image of a second aspect associated with the item is concurrently provided on a corresponding second monitor device disposed in proximity to the static visual indicia of the item provided on the first monitor device.

Thus, embodiments of the present invention facilitate increased exposure of a promoted property or other item by providing a static visual indicia thereof, while concurrently providing additional detail to an interested party in the form of at least one dynamic visual indicia. That is, the static visual indicia may comprise still images or other data related to that property, while the at least one dynamic visual indicia may comprise virtual tours of various aspects of that property. In providing the additional information as one or more dynamic images, little or no affirmative action is required by the interested party. The dynamic images provided concurrently with the static image may advantageously attract and keep the attention of the interested party over a presentation involving a static image alone. Also, since the interested party does not have to perform any work in order to view the dynamic images and there is no time delay in receiving the additional information, the interested party may be more attuned to the promoted item as compared to a less user-friendly system in which the interested party may have to spend significant time and effort in actively pursuing the additional information. Such embodiments of the present invention may be physically provided in various public venues, such as, for example, at a shopping mall, at a transportation hub, or at other locations experiencing sufficient pedestrian traffic in order to enhance exposure of the promoted item. Accordingly, embodiments of the present invention provide these and other significant advantages as described herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a presentation system according to one embodiment of the present invention;

FIG. 2 is a schematic plan view of a presentation system according to one embodiment of the present invention as shown in FIG. 1;

FIG. 3 is a schematic plan view of a presentation system according to an alternate embodiment of the present invention; and

FIG. 4 is a schematic frontal elevation of a presentation system according to another alternate embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Though embodiments of the present invention disclosed herein are described and discussed in terms of property or other real estate, such instances are only exemplary with respect to the applicability of such embodiments. That is, real estate is but one exemplary application of the embodiments of the present invention and the description of the embodiments of the present invention in this regard is not intended to be limiting in any manner. One skilled in the art will thus readily appreciate, from the concepts described herein, that embodiments of the present invention may be applicable to many other items and situations within the spirit and scope of the disclosure.

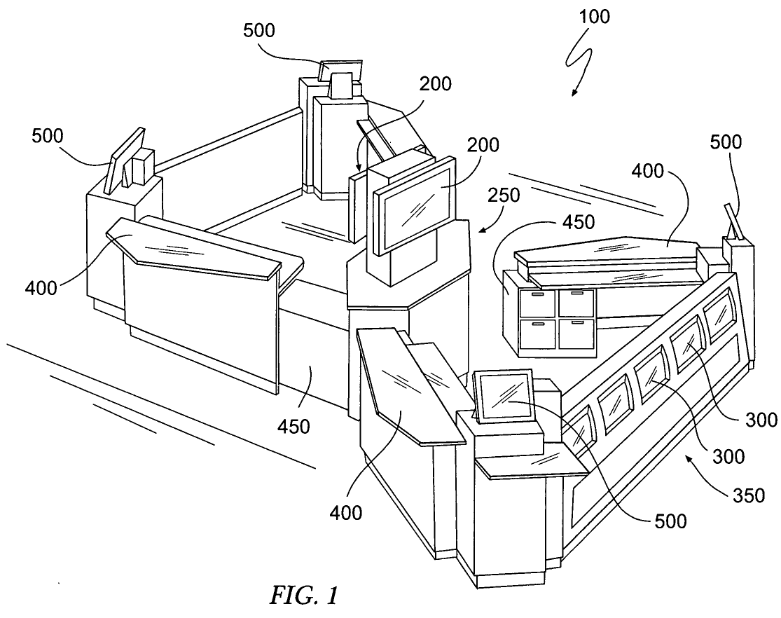

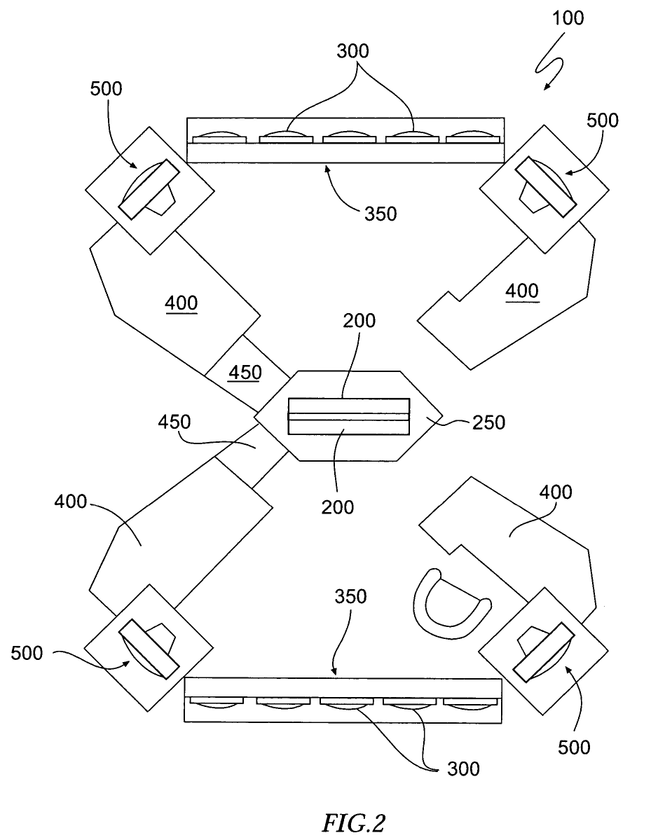

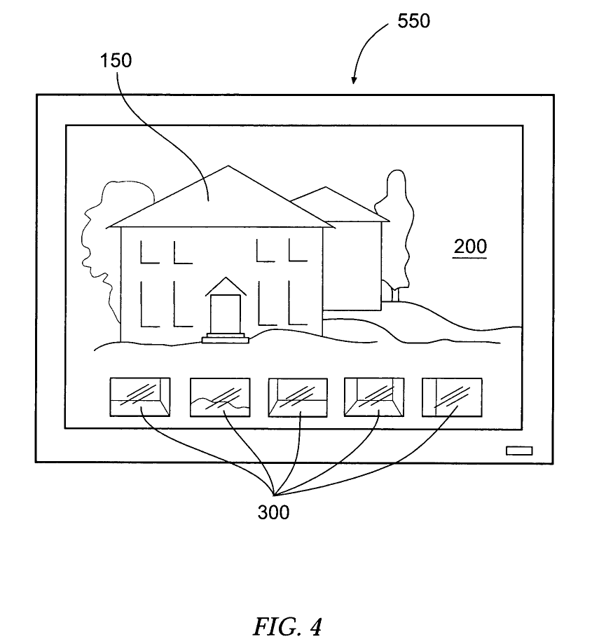

FIGS. 1 and 2 schematically illustrate one embodiment of a presentation system according to the present invention, the system being indicated generally by the numeral 100. The system 100 includes a first viewing medium 200 and at least one corresponding second viewing medium 300, wherein each viewing medium 200,300 may comprise an electronic monitor device such as, for example, a cathode ray tube (CRT), a liquid crystal display (LCD), a light-emitting diode (LED) array, a plasma screen, a projector device, or any other suitable device for providing a visual indicia or other representation of a unit or item 150 (wherein element 150 is illustrated in FIG. 4). The first viewing medium 200 is configured to display a static visual indicia of the unit or item 150 being presented by the system 100. In instances where the unit or item 150 comprises real property, such as a house and accompanying land, the static visual indicia may comprise, for example, an image of the house/land, a drawing or sketch of the property such as a floor plan, and/or any specification such as acreage, house square footage, local school assignments, annual property taxes, or any special features of the property. Such a static visual indicia may be displayed on the first viewing medium 200, for example, as a form of an electronic flier or listing sheet. In addition, the static visual indicia may all be provided on a single first viewing medium 200 or, in the alternative, may be provided on several discrete monitors.

In the embodiment shown in FIGS. 1 and 2, each first viewing medium 200 includes five corresponding monitors or second viewing media 300, though one skilled in the art will appreciate that the number of second viewing media 300 may vary considerably and the number shown is for example only and not intended to be limiting in any manner with respect to the present invention. The second viewing medium 300 is configured to display at least one dynamic visual indicia associated with an aspect of the unit or item 150. Such dynamic visual indicia may be any form of a movie, a film clip, an animation, or any other appropriate moving image of the unit or item 150. The dynamic visual indicia may also include, for instance, scrolling text, text advanced frame by frame, or other configurations for dynamically providing textual information, wherein such textual information may be related to one or more specifications regarding the property or item 150 or aspects thereof. In instances where the unit or item 150 comprises real property, such as a house and accompanying land, each dynamic visual indicia may comprise, for example, a virtual tour associated with an aspect of the property. The aspect of the property may comprise, for instance, a room in or other portion of the house, the surrounding yard, highlighted features of the property, the immediate neighborhood or other surrounding environment, local attractions, or any other suitable information related to that property. In instances where the promoted item is not real estate, the aspect of the item 150 may comprise, for example, the item 150 in operation or a time-lapse representation of the item 150.

A virtual tour of an aspect of the property may comprise, for instance, a panoramic view, continuous scan, or multiple successive views of a room. For instance, one monitor of the second viewing media 300 may provide a virtual tour of the kitchen, while another monitor of the second viewing media 300 provides a virtual tour of the family room. Another monitor of the second viewing media 300 may provide a virtual tour of the back yard, and another monitor may provide a virtual tour of the front yard, while the last monitor may provide a virtual tour of the swimming pool and wet bar as a highlighted feature. Such “virtual tours” may be extended to many different forms of items 150, as described herein. Any monitor of the second viewing media 300 not displaying a dynamic visual indicia may be left as a blank screen or, in some instances, may be made to display another image, whether static or dynamic. Such an image may be, for example, a static image of the property, property specifications, a screen saver, or the logo of the company promoting the item.

As further shown in FIGS. 1 and 2, a physical embodiment of the system 100 according to the present invention may comprise, for example, a center island 250 having one or more first viewing media 200 engaged therewith for providing one or more static visual indicia of the property or item 150 being promoted. In one instance, the first viewing media 200 may include two opposing displays, such as flat panel LCDs or plasma monitors. Outwardly of each first viewing media 200 is disposed a corresponding set of second viewing media 300 in the form of a bank of one or more additional monitors 350, though the additional monitors may be disposed in many different manners in addition to that shown. For instance, five such monitors may be provided in the same plane as the first viewing medium 200 (not physically outward thereof) and/or surrounding the same (i.e. one or more monitors along each side of the first viewing medium 200). The first viewing medium 200 on the center island 250 is thus configured to display a still or static image of a particular item such as, for example, a front view of a particular house. In such an instance, each of the monitors on the corresponding outward bank 350 of second viewing media 300 concurrently provide a moving picture or virtual tour of a room in that house or other aspect associated with the property. In this manner, the first and second viewing media 200,300 are disposed in proximity and relative to each other so as to be concurrently viewable by the target audience.

The first and second viewing media 200,300, when arranged as shown in FIGS. 1 and 2, allows the system 100 to be configured so as to be manned by an attendant. The separation between the first viewing medium 200 and the bank 350 of second viewing media 300 provides accommodation space for the attendant (not shown). Counters 400 may extend between each of the opposed ends of the bank 350 of second viewing media 300 toward the center island 250 so as to provide customer service counter space. In order to provide ingress and egress for the attendant with respect to the accommodation space, a gate member 450 may be provided, wherein the gate member 450 may comprise, for example, a rolling file cabinet or an extension for the counter 400 capable of folding or sliding with respect to the counter 400. At opposing ends of the bank of monitors 350, and at the ends of the counters 400 extending diagonally outward of the center island 250, one or more computer terminal devices 500 may be provided. Such computer terminal devices may be configured to provide, for example, data regarding the property being displayed, or allow an interested party to search for other listed properties or items 150. More particularly, the property data may include, for instance, room dimensions, extra features, property tax rates, local schools, or the like (and may also be displayed, in some instances, on either or both of the first and second viewing media 200,300). The search feature may provide other houses, properties, or other items 150, or may be expanded to provide, for instance, MLS or other national listings for such property or other items 150 in different geographical areas, statewide or countrywide, in different classes, by price or other parameters, or according to other appropriate manners of classification. In some instances, the computer terminal devices 500 may be configured such that a selected listing from a search may be displayed as a corresponding static visual indicia/concurrent dynamic visual indicia on one set of first and second viewing media 200,300.

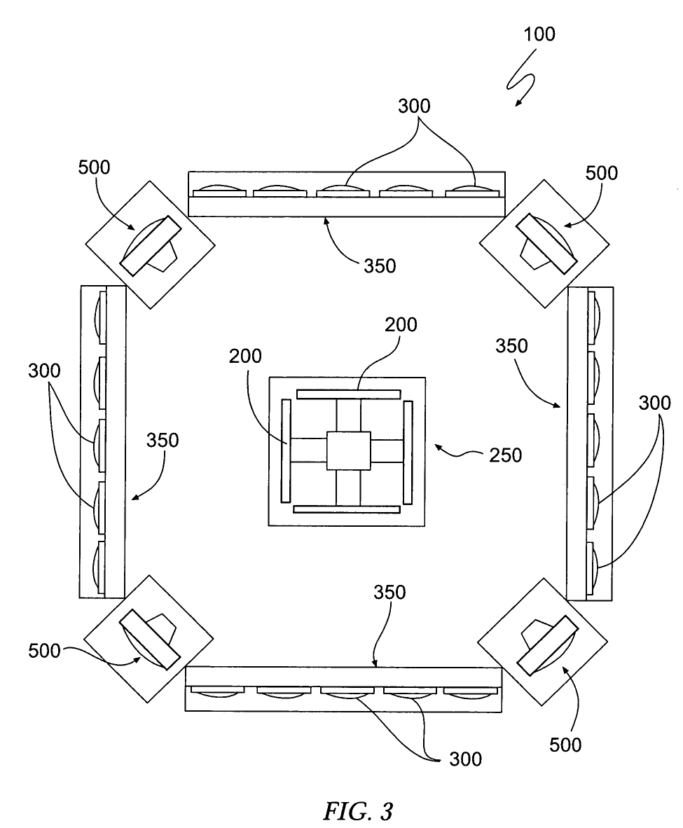

FIGS. 3 and 4 illustrate various alternate embodiments of a system 100 as disclosed herein. FIG. 3, for example, illustrates one alternate embodiment in which the system 100 is not manned by an attendant. In such instances, the system 100 includes four first viewing media 200 extending around the center island 250, with each first viewing media 200 having a corresponding bank of monitors 350 disposed outwardly thereof comprising the second viewing media 300 portion of the system 100. Accordingly, each side of the system 100 includes one set of first and second viewing media 200,300. In some instances, partitions (not shown) may extend from each corner of the center island 250, between adjacent monitors comprising the first viewing media 200, to the computer terminal device 500 corresponding to that corner. Such partitions may, for example, serve to isolate sets of first and second viewing media 200,300 from each other, and may also provide an opportunity for advertising, a company logo, or the like to be displayed. The area between the first and second viewing media 200,300 may also comprise, for instance, counter space for advertising, brochures, or other appropriate media. In other instances, the space between the first and second viewing media 200,300 may be substantially eliminated to provide a more compact footprint. In still other instances, as particularly shown in FIG. 4, the first and second viewing media 200,300 may be integrated into a single monitor device 550 such that the static and dynamic indicia can be concurrently viewed on the same screen, in a type of “picture-in-picture” configuration. Such an embodiment may be advantageous in instances where no floor space is available to accommodate the system 100, wherein the monitor 550 may be hung on a wall.

In some embodiments, the system 100 may further include one or more computer devices capable of executing the methods described herein, particularly processing and directing the static and dynamic visual indicia for the item 150 to the appropriate ones of the first and second viewing media 200,300. The property or item 150 displayed by the system 100 may thus have many different parameters associated with the display thereof on a set of first and second viewing media 200,300 such as, for example, display time, display frequency, the set of first and second viewing media 200,300 on which the item 150 is displayed, the number of dynamic visual indicia being displayed, and the like. For example, if the system 100 includes few listings, each listing will get proportionally more exposure in a rotating or periodic manner. If many listings are present, the listing carrying more or a commission (on a percentage or other monetary amount basis) may have proportionally more exposure than a lesser commission or lesser incentive property or item 150. That is, a property or item 150 may appear more frequently or be displayed for a longer period of time in relation to the conditions in which it was listed with the system 100. The nature of the listed properties or items 150 in relation to the provided exposure may, however, take many different forms, as will be understood by one skilled in the art.

Embodiments of the present invention thus facilitate increased exposure and promotion of a property or other item 150 by providing additional detail in the form of virtual tours or other dynamic visual indicia of various aspects of that property or item 150, over a still or static visual indicia in the form of an image or other data related to that property or item 150 that is also displayed. In this manner, the promotional information is provided, as concurrent static and dynamic images, to the target audience with little or no affirmative action required by the interested party and in a time-efficient manner. Potentially-interested parties are also provided with self-help computer terminal devices 500 in close proximity to the displayed property or item 150, but also have access to live attendants staffing the system 100. Such a system may be provided in various venues, such as, for example, at a shopping mall, at a transportation hub, or at other locations experiencing sufficient pedestrian traffic so as to enhance and maximize exposure for the listed units or items 150.

One skilled in the art will further appreciate that embodiments of the system 100 described herein also support corresponding methods of operation, wherein, for example, such a method may comprise presenting a unit by providing a static visual indicia of the unit on a first viewing medium 200 and concurrently providing at least one dynamic visual indicia of an aspect associated with the unit on a corresponding second viewing medium 300 disposed in proximity to the static visual indicia of the unit provided on the first viewing medium 200. In addition, one skilled in the art will appreciate the myriad of possibilities for application of the disclosed system 100. For example, besides real property, embodiments of the system 100 may be applied to vehicles such as automobiles or boats, other goods, merchandise, or service, or other physical item being promoted. However, such a system 100 may also be applied to promote, for instance, tourist attractions, landmarks, events, or the like. Accordingly, embodiments of the system 100 may generally be applied to any situation that may benefit from increased exposure by displaying a static visual indicia concurrently with one or more corresponding dynamic visual indicia of the item or event being promoted.

Many modifications and other embodiments of the inventions set forth herein will come to mind to one skilled in the art to which these inventions pertain having the benefit of the teachings presented in the foregoing descriptions and the associated drawings. For example, one skilled in the art will appreciate that, in preparing the item 150 for display on the system 100, appropriate content with respect to that item 150 must be obtained in electronic form, whether by reception from the party promoting the item 150 or by dispatching a representative to obtain the necessary images and specifications. Further, the system 100 may also require one or more computer devices capable of executing the methods described herein, particularly processing and directing the static and dynamic visual indicia for the item 150 to the appropriate ones of the first and second viewing media 200,300 and other functions associated with the system 100. A centralized content scheme may also be implemented, wherein contents such as images or specifications of the promoted item(s) 150 may be electronically distributed over a network, such as the Internet, to individual systems discretely disposed with respect thereto. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for presenting a unit, comprising:
a first viewing medium configured to provide a static visual indicia of the unit; and
at least one second viewing medium disposed in proximity to the first viewing medium, the at least one second viewing medium being configured to provide a dynamic visual indicia of an aspect associated with the unit, concurrently with the static visual indicia of the unit provided by the first viewing medium.

2. A system according to claim 1 wherein the first viewing medium and the at least one second viewing medium further comprise an electronic monitor device configured to display the respective visual indicia.

3. A system according to claim 2 wherein the first viewing medium is discrete with respect to the at least one second viewing medium.

4. A system according to claim 2 wherein the at least one second viewing medium is integral with the first viewing medium.

5. A system according to claim 1 wherein the static visual indicia further comprises at least one of an image of the unit, a drawing of the unit, and a specification of the unit.

6. A system according to claim 1 wherein the dynamic visual indicia further comprises at least one of a moving image of the aspect of the unit, an animation of the aspect of the unit, and moving text associated with the aspect of the unit.

7. A system according to claim 1 wherein the aspect of the unit further comprises at least one of a portion of the unit, an environment associated with the unit, operation of the unit, a time-lapse representation of the unit, and a tour of the unit.

8. A system according to claim 1 wherein the first viewing medium and the at least one second viewing medium are disposed in proximity to each other so as to be capable of being concurrently viewed.

9. A system for displaying an item, comprising:
a first monitor device configured to display a static image of a first aspect of the item; and
at least one second monitor device disposed in proximity to the first monitor device, the at least one second monitor device being configured to display a dynamic image of a second aspect associated with the item, concurrently with the static image of the first aspect of the item displayed by the first monitor device.

10. A system according to claim 9 wherein the first monitor device is discrete with respect to the at least one second monitor device.

11. A system according to claim 9 wherein the at least one second monitor device is integral with the first monitor device.

12. A system according to claim 9 wherein the static image further comprises at least one of a graphical representation of the first aspect of the item, a drawing of the first aspect of the item, and a specification of the first aspect of the item.

13. A system according to claim 9 wherein the dynamic image further comprises at least one of a moving graphical representation of the second aspect of the item, an animation of the second aspect of the item, and moving text associated with the second aspect of the item.

14. A system according to claim 9 wherein the second aspect of the item further comprises at least one of a portion of the item, an environment associated with the item, operation of the item, a time-lapse representation of the item, and a tour of the item.

15. A system according to claim 9 wherein the first viewing medium and the at least one second viewing medium are disposed in proximity to each other so as to be capable of being concurrently viewed.

16. A method of presenting a unit, comprising:
providing a static visual indicia of the unit on a first viewing medium; and
concurrently providing at least one dynamic visual indicia of an aspect associated with the unit on a corresponding second viewing medium disposed in proximity to the static visual indicia of the unit provided on the first viewing medium.

17. A method according to claim 16 wherein the first and second viewing medium further comprise an electronic monitor device configured to display the respective visual indicia and providing at least one dynamic visual indicia further comprises providing at least one dynamic visual indicia on a discrete monitor device with respect to the monitor device displaying the static visual indicia.

18. A method according to claim 16 wherein the first and second viewing medium further comprise an electronic monitor device configured to display the respective visual indicia and providing at least one dynamic visual indicia further comprises providing at least one dynamic visual indicia on a monitor device integral with the monitor device displaying the static visual indicia.

19. A method according to claim 16 wherein providing a static visual indicia further comprises providing a static visual indicia comprising at least one of an image of the unit, a drawing of the unit, and a specification of the unit.

20. A method according to claim 16 wherein providing at least one dynamic visual indicia further comprises providing at least one dynamic visual indicia comprising at least one of a moving image of the aspect of the unit, an animation of the aspect of the unit, and moving text associated with the aspect of the unit.

21. A method according to claim 16 wherein providing at least one dynamic visual indicia of an aspect associated with the unit further comprises providing at least one dynamic visual indicia of an aspect of the unit comprising at least one of a portion of the unit, an environment associated with the unit, operation of the unit, a time-lapse representation of the unit, and a tour of the unit.

22. A method according to claim 16 wherein providing at least one dynamic visual indicia further comprises providing at least one dynamic visual indicia on a second viewing medium disposed in proximity to the first viewing medium displaying the static visual indicia such that the viewing media are capable of being concurrently viewed.

23. A method of displaying an item, comprising:
providing a static image of a first aspect of the item on a first monitor device; and
concurrently providing at least one dynamic image of a second aspect associated with the item on a corresponding second monitor device disposed in proximity to the static visual indicia of the item provided on the first monitor device.

24. A method according to claim 23 wherein providing at least one dynamic image further comprises providing at least one dynamic image on a second monitor device discrete with respect to the first monitor device displaying the static image.

25. A method according to claim 23 wherein providing at least one dynamic image further comprises providing at least one dynamic image on a second monitor device integral with the first monitor device displaying the static image.

26. A method according to claim 23 wherein providing a static image of a first aspect further comprises providing a static image of a first aspect comprising at least one of an image of the first aspect, a drawing of the first aspect, and a specification of the first aspect.

27. A method according to claim 23 wherein providing at least one dynamic image of a second aspect further comprises providing at least one dynamic image of a second aspect comprising at least one of a moving image of the second aspect, an animation of the second aspect, and moving text associated with the second aspect.

28. A method according to claim 23 wherein providing at least one dynamic image of the second aspect further comprises providing at least one dynamic image of the second aspect comprising at least one of a portion of the item, an environment associated with the item, operation of the item, a time-lapse representation of the item, and a tour of the item.

29. A method according to claim 23 wherein providing at least one dynamic image further comprises providing at least one dynamic image on a second monitor device disposed in proximity to the first monitor displaying the static image such that the monitor devices are capable of being concurrently viewed.
